(19) United States
(12) Patent Application Publication
(10) Pub. No.: US 2011/0188364 A1
(43) Pub. Date: Aug. 4, 2011

(54) OPTICAL DISC DRIVE AND TRACKING METHOD THEREOF

(75) Inventors: Chien-Nan Lin, Hsinchu County (TW); Chao-Ming Huang, Taipei Hsien (TW)

(73) Assignee: MEDIATEK INC., Hsin-Chu (TW)

(21) Appl. No.: 12/699,125

(22) Filed: Feb. 3, 2010

(51) Int. Cl. G11B 27/36

(52) U.S. Cl. 369/53.31; G9B/27.052

(57) ABSTRACT

An optical disc drive and tracking method thereof are disclosed. The optical disc drive includes an optical pickup head, a slip compensation module, a tracking control module and a tracking drive. The optical pickup head generates a detected signal according to an optical signal from an optical disc. The slip compensation module generates a slip compensation signal according to the detected signal. The tracking control module generates a tracking out signal according to the detected signal and the slip compensation signal and, according to the tracking out signal, the tracking drive drives the optical pickup head.

### BACKGROUND OF THE INVENTION

1. Field of the Invention

The present invention relates to optical disc drive, and in particular relates to tracking techniques thereof.

2. Description of the Related Art

In computing, an optical disc drive is a disk drive that uses laser light to read data from optical discs. For example, compact discs, DVDs and blue-ray discs are common types of optical media which can be read by an optical disc drive.

However, the disc surface of optical discs may not always be clean or flawless. A fingerprint or a scrape on the optical disc may cause tracking errors. When a tracking error occurs, reading of the optical disc may fail.

### BRIEF SUMMARY OF THE INVENTION

An optical disc drive and tracking method thereof are disclosed.

The optical disc drive comprises an optical pickup head, a slip compensation module, a tracking control module and a tracking drive. The optical pickup head generates a detected signal according to an optical signal from an optical disc. The slip compensation module generates a slip compensation signal according to the detected signal from the optical pickup head. The tracking control module generates a tracking out signal according to the detected signal and the slip compensation signal. The tracking drive drives the optical pickup head according to the tracking out signal.

The optical disc tracking method disclosed in the invention orientates a light beam from an optical pickup head to track an optical disc. The method detects an optical signal from the optical disc to generate a detected signal and generates a slip compensation signal according to the detected signal. Based on the detected signal and the slip compensation signal, the method further generates a tracking out signal to drive the optical pickup head accordingly.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 depicts an exemplary embodiment of the optical disc drive of the invention;

FIG. 2 shows an exemplary arrangement of photo detectors of a photo detector integrated circuit (PDIC) of the invention; and

FIGS. 3, 4, 5 and 6 show embodiments of the tracking control module 108 and the slip controller 106 of FIG. 1.

### DETAILED DESCRIPTION OF THE INVENTION

The following description shows several exemplary embodiments carrying out the invention. This description is made for the purpose of illustrating the general principles of the invention and should not be taken in a limiting sense. The scope of the invention is best determined by reference to the appended claims.

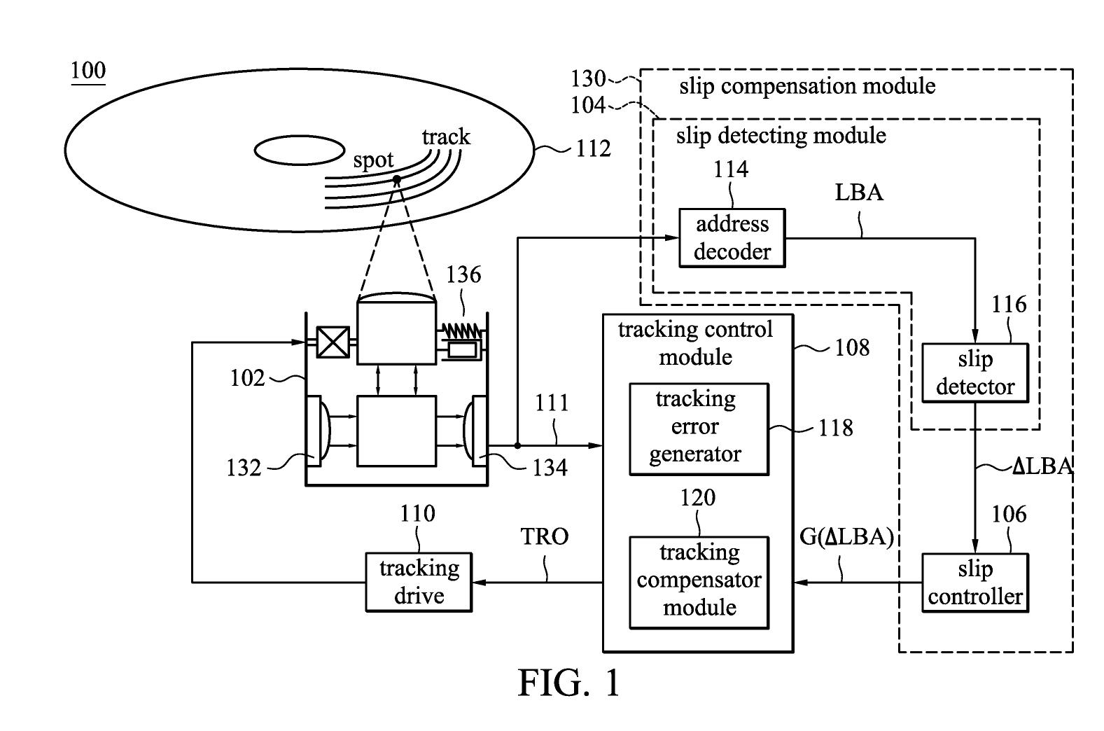

FIG. 1 depicts an exemplary embodiment of the optical disc drive of the invention. The optical disc drive 100 comprises an optical pickup head 102, a slip compensation module 130, a tracking control module 108 and a tracking drive 110.

The optical pickup head 102 generates a detected signal 111 according to an optical signal from an optical disc 112. In this embodiment, the optical pickup head 102 may include a laser diode 132 emitting a light beam to the optical disc 112, photo detector integrated circuit (PDIC) 134 detecting and/or processing the optical signal from the optical disc 112, and a tracking actuator 136 orientating the light beam. The detected signal 111 may include a radio frequency (RF) signal and/or a wobble signal (WOB). As shown in FIG. 1, the detected signal 111 is sent to the slip compensation module 130 to generate a slip compensation signal, such as G(ΔLBA) in this embodiment. Based on the slip compensation signal, such as G(ΔLBA), and the detected signal 111, the tracking control module 108 generates a tracking out signal TRO. The tracking drive 110 operates according to the tracking out signal TRO to drive the optical pickup head 102.

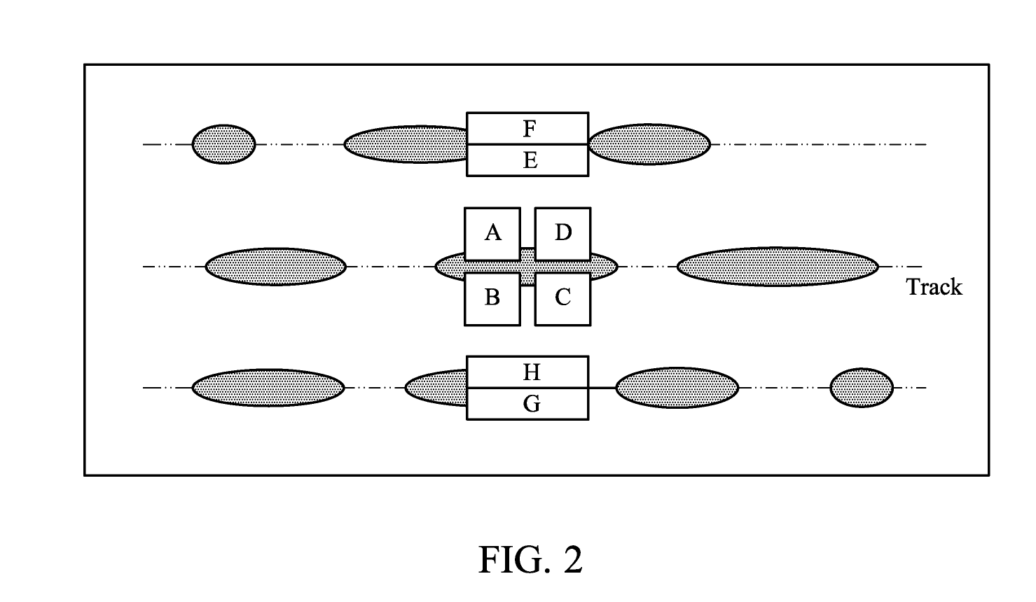

FIG. 2 shows an exemplary arrangement of photo detectors of a photo detector integrated circuit (PDIC) of the invention. The detected signal may be obtained according to A, B, C, D, E, F, G and H signals from A, B, C, D, E, F, G and H regions shown in the figure. FIG. 2 does not intend to limit the components of the detected signal 111. In fact, the components of the detected signal 111 are dependent on the structure of the optical pickup head 102. The tracking techniques disclosed in the invention can be applied in every disc drives.

Referring back to FIG. 1, the slip compensation module 130 may comprise a slip detecting module 104 and a slip controller 106, which are designed to generate the slip compensation signal, such as G(ΔLBA), to compensate for a tracking slip. In this embodiment, the slip detecting module 104 comprises an address decoder 114 and a slip detector 116. The address decoder 114 may decode the detected signal 111, which may include the radio frequency (RF) signal and/or the wobble signal (WOB), to obtain current address, such as logical block address (LBA), of data from the reading spot. According to the current address, such as LBA, the slip detector 116 outputs a slip vector, such as ΔLBA, that indicates a slip amount and a slip direction of the light beam. The slip controller 106 generates the slip compensation signal G(ΔLBA) according to the slip vector ΔLBA. In other embodiments, the slip detecting module 104 may be realized by other techniques. For example, the address decoder 114 may be omitted and the slip vector ΔLBA may be obtained from the vibration of the radio frequency (RF) signal and/or the wobble signal (WOB) without decoding the current address of the optical disc 112.

A slip compensation is performed by the tracking control module 108. As shown, the tracking control module 108 receives the detected signal 111 and the slip compensation signal G(ΔLBA) to generate a tracking out signal TRO for the tracking drive 110. Because the tracking out signal TRO has taken the tracking slip into account, the tracking drive 110 drives the tracking actuator 136 of the optical pickup head 102 to properly orientate the light beam to overcome the tracking slip.

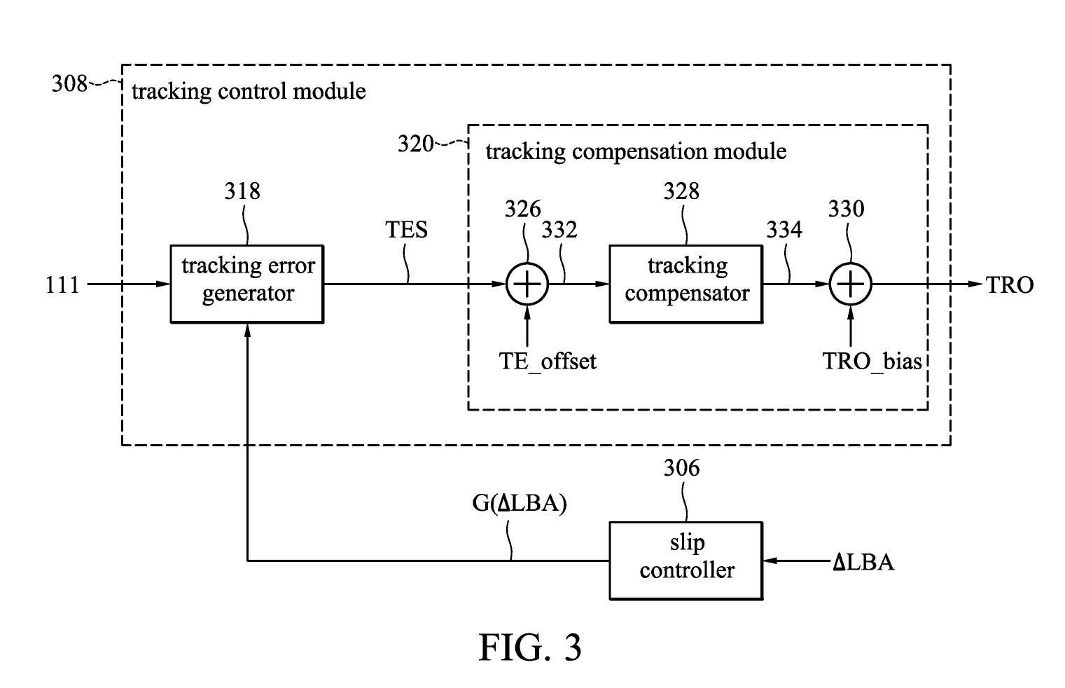

As shown in FIG. 1, the tracking control module 108 comprises a tracking error generator 118 and a tracking compensation module 120. The design of the tracking error generator 118 or/and the tracking compensation module 120 may be dependent on the slip compensation signal G(ΔLBA) generated by the slip controller 106. FIGS. 3, 4, 5 and 6 each show an embodiment of the tracking control module 108 and the slip controller 106.

In FIG. 3, the tracking control module 308 comprises a tracking error generator 318 and a tracking compensation module 320. In this embodiment, the tracking slip is mainly compensated by the tracking error generator 318. As shown, the tracking error generator 318 generates a tracking error signal TES according to the detected signal 111 from the optical pickup head (102 of FIG. 1) and the slip compensation signal G(ΔLBA) from the slip controller 306. The tracking compensation module 320 receives the tracking error signal TES to generate the tracking out signal TRO.

The tacking error generator 318 may generate the tracking error signal TES according to a modified differential push-pull (DPP) formula. For example, an original differential push-pull formula of the optical pickup head 102 may be:

TES=MPPO−KSpp*SPPO, (1)

where MPPO represents a main beam push-pull, SPPO represents a side beam push-pull and KSpp represents a gain coefficient. In a case wherein the detected signal 111 is obtained according to A, B, C, D, E, F, G and H signals from A . . . H regions shown in FIG. 2, the main beam push-pull MPPO and side beam push-pull SPPO could be:

MPPO=(A+D)−Mpp_Kb*(B+C); and

SPPO=(F+H)−Spp_Kb*(E+G),

where Mpp_Kb is a main beam push-pull coefficient and Spp_Kb is a side beam push-pull coefficient. Thus, the differential push-pull Formula (1) can be further transformed to the following formula:

TES=[(A+D)−Mpp_Kb*(B+C)]−KSpp*[(F+H)−Spp_Kb*(E+G)]. (2)

Referring to FIG. 3, the tracking error generator 318 may generate the tracking error signal TES according to an estimation function modified from the Formula (2). The modified differential push-pull formula could be as follows:

TES=[(A+D)−Mpp_Kb_{new}*(B+C)]=KSpp_{new}*[(F+H)−Spp_Kb_{new}*(E+G)]. (3)

In the modified differential push-pull formula (3), Mpp_Kb_{new} represents a main bean push-pull coefficient, Spp_Kb_{new} represents a side beam push-pull coefficient and KSpp_{new} represents a gain coefficient, and at least one of the main bean push-pull coefficient Mpp_Kb_{new}, the side beam push-pull coefficient Spp_Kb_{new} and the gain coefficient KSpp_{new} could be dependent on the slip compensation signal G(ΔLBA) from the slip controller 306. The slip compensation signal G(ΔLBA) may comprise at least one of a first portion g₁(ΔLBA) for the main bean push-pull coefficient Mpp_Kb_{new}, a second portion g₂(ΔLBA) for the side beam push-pull coefficient Spp_Kb_{new}, and a third portion g₃(ΔLBA) for the gain coefficient KSpp_{new}. In one embodiment, g₁(ΔLBA) and g₃(ΔLBA) may be positive when the tracking slips outward (ex. the slip vector ΔLBA is positive) and may be negative when the light beam slips inward (ex. the slip vector ΔLBA is negative), and g₂(ΔLBA) may be negative when the tracking slips outward the optical disc (ex. the slip vector ΔLBA is positive) and may be positive when the light beam slips inward (ex. the slip vector ΔLBA is negative). However, the relations between the portions of the slip compensation signal G(ΔLBA) and the slip directions could be modified according to different design requirements. The main bean push-pull coefficient Mpp_Kb_{new}, side beam push-pull coefficient Spp_Kb_{new} and the gain coefficient KSpp_{new} of the modified differential push-pull Formula (3) may be represented by the following formulas:

Mpp_Kb_{new}=Mpp_Kb+g₁(ΔLBA);

Spp_Kb_{new}=Spp_Kb+g₂(ΔLBA); and

KSpp_{new}=KSpp+g₃(ΔLBA),

where Mpp_Kb, Spp_Kb and KSpp are the main beam push-pull coefficient, side beam push-pull coefficient and gain coefficient used in the conventional differential push-pull Formula (2). Though in this embodiment, the effect of the slip compensation signal is in the form of offsets added to the coefficients, it could be in the form of gains multiplying the coefficients or any other forms according to different design requirements.

Furthermore, as shown in the embodiment of FIG. 3, the tracking compensation module 320 may comprise an adder 326, a tracking compensator 328 and another adder 330. The adder 326 is optional, adding a tracking error offset TE_offset to the tracking error signal TES to generate a biased tracking error signal 332. The tracking error offset TE_offset may be determined when the optical disc drive 100 performs a calibration procedure before, during or after reading the optical disc 112. For example, the calibration procedure could be performed when the optical disc drive 100 begins to read the optical disc 112. The tracking compensator 328 receives the biased tracking error signal 332 to generate an unbiased tracking out signal 334. The adder 330 is optional, adding a tracking out bias TRO_bias to the unbiased tracking out signal 334 to generate the tracking out signal TRO. The tracking out bias TRO_bias may also be determined by the calibration procedure. However, the TE_offset and the TRO_bias could be generated by many other ways, such as given by the user or designer.

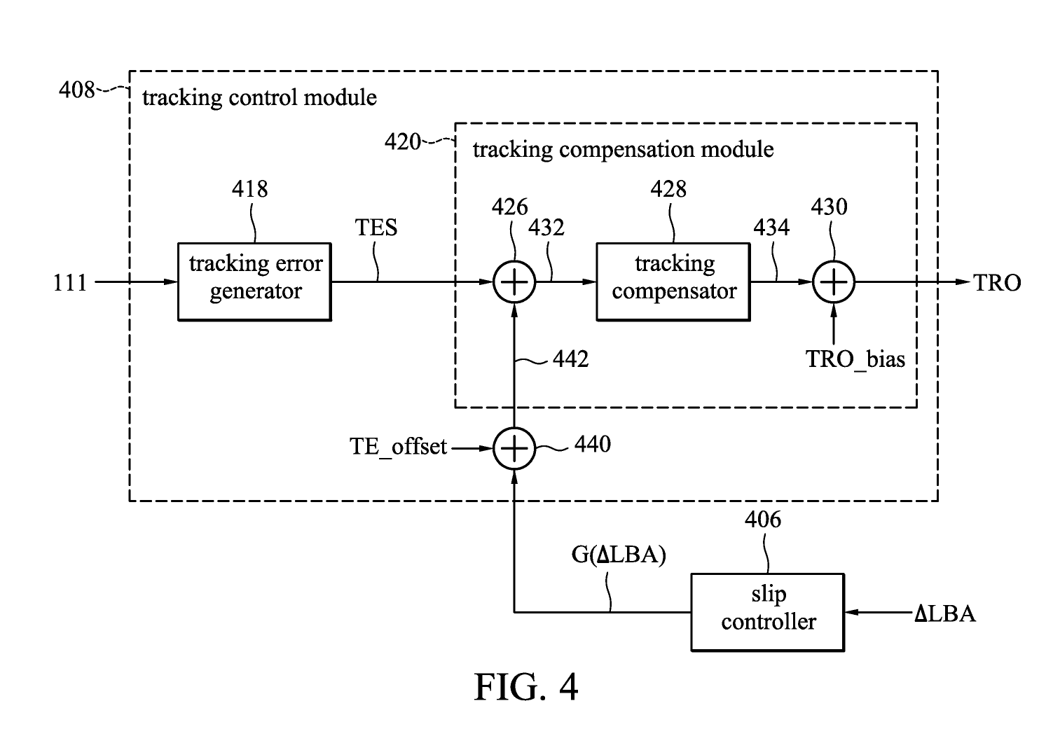

Referring to the embodiment shown in FIG. 4, the slip compensation is accomplished by compensating a tracking error offset TE_offset according to a slip compensation signal G(ΔLBA) from slip controller 406. The tracking error offset TE_offset may be determined according to the calibration procedure the optical disc drive 100 performs when beginning to read the optical disc 112. However, the TE_offset could be generated by many other ways, such as given by the user or designer.

This paragraph discusses the structure of the tracking control module 408. The tracking error generator 418 generates a tracking error signal TES according to the detected signal 111, wherein the tracking error generator 418 may generate the tracking error signal TES according to the differential push-pull Formula (1) provided by the manufacturers of the optical pickup head 102. In this embodiment, the tracking compensation module 420 comprises an adder 426, a tracking compensator 428 and another adder 430. The adder 426 is designed for adding a compensated tracking error offset 442 to the tracking error signal TES to generate a compensated tracking error signal 432. The tracking compensator 428 receives the compensated tracking error signal 432 to output an unbiased tracking out signal 434. The adder 430 is optional, adding a tracking out bias TRO_bias to the unbiased tracking out signal 434 to generate the tracking out signal TRO. Similarly, the tracking out bias TRO_bias may be determined according to the calibration procedure the optical disc drive 100 performs when beginning to read the optical disc 112. However, the TRO_bias could be generated by many other ways, such as given by the user or designer. As shown, the adder 440, adding the slip compensation signal G(ΔLBA) to the tracking error offset TE_offset, may be provided to generate the compensated tracking error offset 442. In one embodiment, the slip controller 406 makes the slip compensation signal G(ΔLBA) positive when the light beam slips outward (the slip vector ΔLBA is positive), and makes the slip compensation signal G(ΔLBA) negative when the light beam slips inward the optical disc (the slip vector ΔLBA is negative). However, the relations between the slip compensation signal G(ΔLBA) and the slip directions could be modified according to different design requirements.

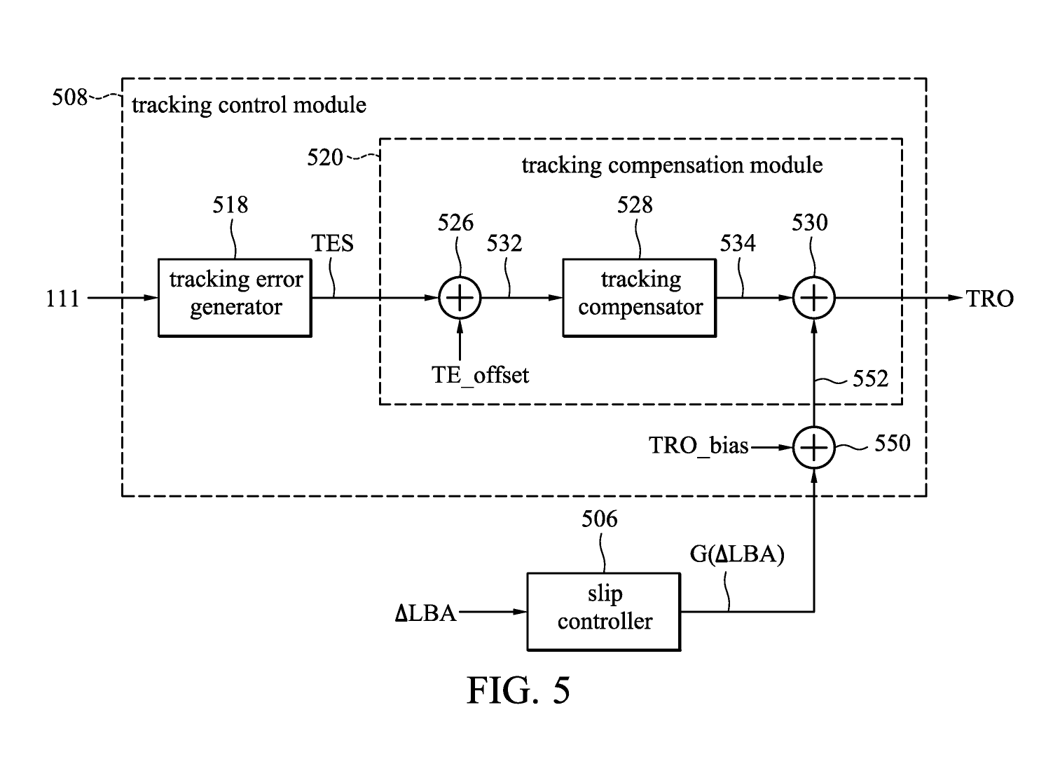

Referring to the embodiment shown in FIG. 5, the slip compensation is accomplished by compensating a tracking out bias TRO_bias according to a slip compensation signal G(ΔLBA) from slip controller 506. The tracking out bias TRO_bias may be determined according to the calibration procedure the optical disc drive 100 performs when beginning to read the optical disc 112. However, the TRO_bias could be generated by many other ways, such as given by the user or designer.

This paragraph discusses the structure of the tracking control module 508. The tracking error generator 518 generates a tracking error signal TES according to the detected signal 111, wherein the tracking error generator 518 may generate the tracking error signal TES according to the differential push-pull Formula (1) provided by the manufacturers of the optical pickup head 102. The tracking compensation module 520 comprises an adder 526, a tracking compensator 528 and another adder 530. The adder 526 is optional, adding a tracking error offset TE_offset to the tracking error signal TES to generate a compensated tracking error signal 532. Similarly, the tracking error offset TE_offset may be determined according to the calibration procedure the optical disc drive 100 performs when beginning to read the optical disc 112. However, the TE_offset could be generated by many other ways, such as given by the user or designer. The tracking compensator 528 receives the compensated tracking error signal 532 to output an unbiased tracking out signal 534. The adder 530 is designed for adding a compensated tracking out bias 552 to the unbiased tracking out signal 534 to generate the tracking out signal TRO. As shown, the adder 550, adding the slip compensation signal G(ΔLBA) to the tracking out bias TRO_bias, may be provided to generate the compensated tracking out bias 552. The slip controller 506 makes the slip compensation signal G(ΔLBA) negative when the light beam slips outward (the slip vector ΔLBA is positive), and makes the slip compensation signal G(ΔLBA) positive when the light beam slips inward (the slip vector ΔLBA is negative). However, the relations among the slip compensation signal G(ΔLBA), the slip vector ΔLBA and the slip directions could be modified according to different design requirements.

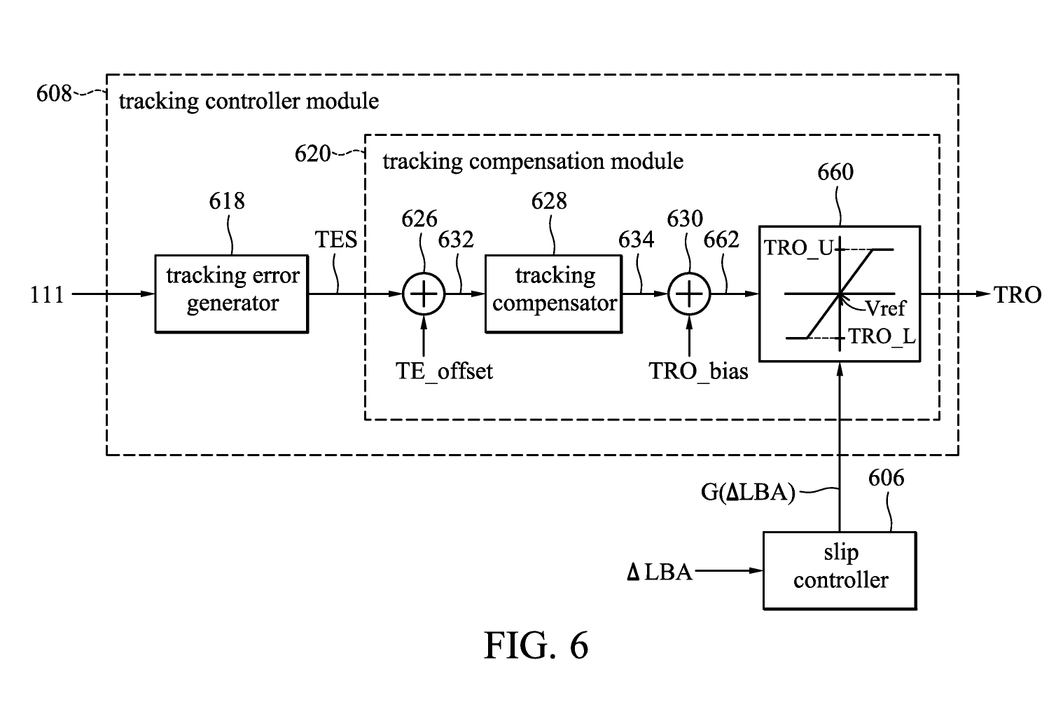

Referring to the embodiment shown in FIG. 6, the slip compensation is accomplished by adjusting an upper limit and a lower limit of the tracking out signal TRO. As shown, the tracking compensation module 620 may include a signal clamping device 660 which clamps the tracking out signal TRO within a lower limit TRO_L and an upper limit TRO_U. For slip compensation, the values of the lower limit TRO_L and the upper limit TRO_U are determined according to a slip compensation signal G(ΔLBA) from a slip controller 606.

This paragraph discusses the structure of the tracking control module 608. The tracking error generator 618 generates a tracking error signal TES according to the detected signal 111, wherein the tracking error generator 618 may generate the tracking error signal TES according to the differential push-pull Formula (1) provided by the manufacturers of the optical pickup head 102. The tracking compensation module 620 comprises an adder 626, a tracking compensator 628, another adder 630 and a signal clamping device 660. The adder 626 is optional, adding a tracking error offset TE_offset to the tracking error signal TES to generate a compensated tracking error signal 632. Similarly, the tracking error offset TE_offset may be determined according to the calibration procedure the optical disc drive 100 performs when beginning to read the optical disc 112. However, the TE_offset could be generated by many other ways, such as given by the user or designer. The tracking compensator 628 receives the compensated tracking error signal 632 to output an unbiased tracking out signal 634. The adder 630 is optional, adding a tracking out bias TRO_bias to the unbiased tracking out signal 634 to generate an unclamped tracking out signal 662. After being processed by the signal clamping device 660, the tracking out signal TRO is generated. The object lens of the pickup head 102 may be controlled according to the tracking out signal TRO. When the tracking out signal TRO is greater than a reference voltage Vref, the object lens may move inward. Oppositely, when the tracking out signal TRO is smaller than the reference voltage Vref, the object lens may move outward. The signal clamping device 660 outputs the value of the unclamped tracking out signal 662 as the tracking output signal TRO when the unclamped tracking out signal 662 is between the lower limit TRO_L and the upper limit TRO_U. When the unclamped tracking out signal 662 is greater than the upper limit TRO_U, the signal clamping device 660 outputs the upper limit TRO_U as the tracking out signal TRO. When the unclamped tracking out signal 662 is lower than the lower limit TRO_L, the signal clamping device 660 outputs the lower limit TRO_L as the tracking out signal TRO. The signal clamping device 660 is adaptive. As shown, the slip controller 606 outputs a slip compensation signal G(ΔLBA) according to the slip vector ΔLBA, and the signal clamping device 660 modifies the upper and lower limits TRO_U and TRO_L according to the slip compensation signal G(ΔLBA). When light beam slips inward, the upper limit TRO_U may be decreased according to the slip compensation signal G(ΔLBA); for example, TRO_U=TRO_U_P−G(ΔLBA), where G(ΔLBA) is positive and TRO_U_P is the previous value of the upper limit. When light beam slips outwards, the lower limit TRO_L may be increased according to the slip compensation signal G(ΔLBA); for example, TRO_L=TRO_L_P+G(ΔLBA), where G(ΔLBA) is positive and TRO_L_P is the previous value of the lower limit. However, the said TRO_U and TRO_L modification methods are not intended to limit the upper limit TRO_U modification techniques or the lower limit TRO_L modification techniques. The TRO_U, TRO_L modifications could be generated by many other ways, such as given by the user or designer. The relations among the slip compensation signal G(ΔLBA), the slip vector ΔLBA, the slip directions and the decrease/increase of TRO_U/TRO_L could be modified according to different design requirements.

Although in the embodiments shown in FIGS. 3-6, the effect of the slip compensation signal is exerted by adding the offset and/or bias, such as TE_offset and/or TRO_bias, to the signals, it could be exerted by multiplying the signals by the offset and/or bias, or by any ways according to different design requirements.

The blocks and components shown in the exemplary embodiments are not limited to hardware implementation. In other embodiments, the blocks and components shown in the exemplary embodiments may be realized by firmware or software of the optical disc drive.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical disc drive, comprising:
an optical pickup head, generating a detected signal according to an optical signal from an optical disc;
a slip compensation module, generating a slip compensation signal according to the detected signal;
a tracking control module, generating a tracking out signal according to the detected signal and the slip compensation signal; and
a tracking drive, driving the optical pickup head according to the tracking out signal.

2. The optical disc drive as claimed in claim 1, wherein the slip compensation module comprises:
a slip detecting module, estimating a slip vector according to the detected signal; and;
a slip controller, generating the slip compensation signal according to the slip vector.

3. The optical disc drive as claimed in claim 2, wherein the slip detecting module comprises:
an address decoder, decoding the detected signal to obtain a current address of data to be read from the optical disc; and
a slip detector, estimating the slip vector according to the current address decoded by the address decoder.

4. The optical disc drive as claimed in claim 2, wherein the slip vector indicates a slip amount and a slip direction.

5. The optical disc drive as claimed in claim 1, wherein the tracking control module comprises:
a tracking error generator, generating a tracking error signal according to the detected signal and the slip compensation signal; and
a tracking compensation module, receiving the tracking error signal to generate the tracking out signal.

6. The optical disc drive as claimed in claim 5, wherein the tracking error generator performs an estimation function to generate the tracking error signal, and the estimation function includes a main beam push-pull coefficient, a side beam push-pull coefficient and a gain coefficient for transforming the detected signal to the tracking error signal, wherein at least one of the main beam push-pull coefficient, side beam push-pull coefficient and gain coefficient is dependent on the slip compensation signal.

7. The optical disc drive as claimed in claim 1, wherein the tracking control module comprises:
a tracking error generator, generating a tracking error signal according to the detected signal; and
a tracking compensation module, receiving the tracking error signal and the slip compensation signal to generate the tracking out signal.

8. The optical disc drive as claimed in claim 7, wherein the tracking compensation module comprises:
a first adder, adding a compensated tracking error offset, determined by the slip compensation signal, to the tracking error signal; and
a tracking compensator, receiving output of the first adder and outputting the tracking out signal.

9. The optical disc drive as claimed in claim 7, wherein the tracking compensation module comprises:
a tracking compensator, receiving the tracking error signal and outputting an unbiased tracking out signal; and
a second adder, adding a compensated tracking out bias, determined by the slip compensation signal, to the unbiased tracking out signal to generate the tracking out signal.

10. The optical disc drive as claimed in claim 7, wherein the tracking compensation module comprises:
a tracking compensator, receiving the tracking error signal and outputting an unclamped tracking out signal; and
a signal clamping device, clamping the unclamped tracking out signal between a lower limit and an upper limit to generate the tracking out signal, wherein the lower and upper limits are determined according to the slip compensation signal.

11. The optical disc drive as claimed in claim 5, wherein the slip compensation signal is generated according to a slip vector, and the slip vector indicates a slip amount and a slip direction.

12. The optical disc drive as claimed in claim 7, wherein the slip compensation signal is generated according to a slip vector, and the slip vector indicates a slip amount and a slip direction.

13. An optical disc tracking method, orientating a light beam from an optical pickup head to track an optical disc, comprising:
detecting an optical signal from the optical disc to generate a detected signal;
generating a slip compensation signal according to the detected signal;
generating a tracking out signal according to the detected signal and the slip compensation signal; and
driving the optical pickup head according to the tracking out signal.

14. The method as claimed in claim 13, wherein the step of generating the slip compensation signal further comprises:
estimating a slip vector according to the detected signal; and
generating the slip compensation signal according to the slip vector.

15. The method as claimed in claim 14, wherein the step of estimating the slip vector further comprises:
decoding the detected signal to obtain a current address of data to be read from the optical disc; and
estimating the slip vector according to the current address.

16. The method as claimed in claim 14, wherein the slip vector indicates a slip amount and a slip direction.

17. The method as claimed in claim 13, wherein the step of generating the tracking out signal comprises:
generating a tracking error signal according to the detected signal and the slip compensation signal; and
generating the tracking out signal according to the tracking error signal.

18. The method as claimed in claim 17, wherein the step of generating the tracking error signal further comprises:
transforming the detected signal to the tracking error signal according to an estimation function, wherein:
the estimation function includes a main beam push-pull coefficient, a side beam push-pull coefficient and a gain coefficient; and
at least one of the main beam push-pull coefficient, side beam push-pull coefficient and gain coefficient is dependent on the slip compensation signal.

19. The method as claimed in claim 13, wherein the step of generating the tracking out signal further comprises:
generating a tracking error signal according to the detected signal; and
generating the tracking out signal according to the tracking error signal and the slip compensation signal.

20. The method as claimed in claim 19, wherein the step of generating the tracking out signal according to the tracking error signal and the slip compensation signal further comprises:
adding a compensated tracking error offset, determined by the slip compensation signal, to the tracking error signal to generate a compensated tracking error signal; and
generating the tracking out signal according to the compensated tracking error signal.

21. The method as claimed in claim 19, wherein the step of generating the tracking out signal according to the tracking error signal and the slip compensation signal further comprises:
generating an unbiased tracking out signal according to the tracking error signal; and
adding a compensated tracking out bias, determined by the slip compensation signal, to the unbiased tracking out signal to generate the tracking out signal.

22. The method as claimed in claim 19, wherein the step of generating the tracking out signal according to the tracking error signal and the slip compensation signal further comprises:
generating an unclamped tracking out signal according to the tracking error signal; and
clamping the unclamped tracking out signal between a lower limit and an upper limit to generate the tracking out signal, wherein the lower and upper limits are determined according to the slip compensation signal.

23. The method as claimed in claim 17, wherein the slip compensation signal is generated according to a slip vector, and the slip vector indicates a slip amount and a slip direction.

24. The method as claimed in claim 19, wherein the slip compensation signal is generated according to a slip vector, and the slip vector indicates a slip amount and a slip direction.
